(19) United States
(12) Patent Application Publication
(10) Pub. No.: US 2026/0198463 A1
(43) Pub. Date: Jul. 16, 2026

(54) SYSTEMS AND METHODS FOR CARBON CAPTURE AND STORAGE

(71) Applicant: CV CARBON, LLC, Magnolia, TX (US)

(72) Inventors: Jeffrey Frederick Pinsky, Magnolia, TX (US); Jason Jerome Jordan, Magnolia, TX (US); John Jurisich, Magnolia, TX (US); Alfred Lester Jones, Magnolia, TX (US)

(21) Appl. No.: 19/449,696

(22) Filed: Jan. 15, 2026

Related U.S. Application Data
(60) Provisional application No. 63/746,076, filed on Jan. 16, 2025.

(51) Int. Cl. A01K 61/54; A01K 61/90; G06Q 30/018

(52) U.S. Cl. CPC A01K 61/54; A01K 61/90; G06Q 30/018

(57) ABSTRACT

The invention comprises a method for recapturing leaked carbon dioxide from oyster-based carbon storage, comprising calculating a quantity of carbon dioxide stored in sediments beneath and surrounding an oyster colony, determining sediment mobilization activities nearby, measuring a disturbed area of the oyster colony resulting from the sediment mobilization activities and multiplying the disturbed area by a predetermined second carbon dioxide storage rate for the disturbed area to provide a quantity of carbon dioxide leakage, calculating a recapture area by dividing the quantity of carbon dioxide leakage by a product of a predetermined carbon burial rate and a recapture time period, and placing additional cultch material in the aquatic environment, wherein a surface area covered by the additional cultch material is at least equal to the recapture area, to facilitate oyster colonization for recapture of the carbon dioxide leakage.

### CROSS-REFERENCE TO RELATED APPLICATIONS

This application claims the benefit of U.S. Provisional Patent Application No. 63/746,076, filed Jan. 16, 2025, which is incorporated by reference herein in its entirety.

### BACKGROUND

Oyster cultivation provides a method for carbon dioxide capture and storage by removing carbon dioxide from the atmosphere-ocean system and storing it securely in sediments. Multiple studies have shown that oysters efficiently capture carbon from the atmosphere-ocean system and that projects establishing oyster habitat causes net burial of sequestered carbon oxides.

The eastern oyster (Crassostrea virginica) is found along the East and Gulf coasts of North America from the Gulf of St. Lawrence in Canada to the Yucatan Peninsula. Eastern oysters are ecosystem engineers that deliver multiple benefits including carbon capture and storage, enhanced water quality, denitrification, shoreline stabilization, and fishery enrichment. Unfortunately, oyster reefs are one of the most imperiled habitats in the world; roughly 85% of oyster reef habitat has been lost globally over the past 130 years.

Natural oyster colonization is restricted by lack of suitable hard substrate (cultch material) in the environment. Many coastal states in the U.S. have programs for leasing state-owned submerged lands for shellfish cultivation. These state lease programs allow lessees to cultivate oysters by placing clean cultch material (e.g., shell, recycled concrete, river rock, or limestone) on otherwise soft substrate to create oyster habitat.

Once cultch material is colonized by oyster larvae, the oysters grow and efficiently remove both organic and inorganic carbon at high rates. The carbon captured by oysters is converted to biomass, concentrated waste, and shell. As oyster reefs accrete, much of the captured carbon is trapped and buried in stratified depositional layers beneath the living surface of the reef. This method of carbon dioxide capture and disposal is consistent with requirements for secure geological storage.

However, there remains a need for methods and systems to monitor, verify, and manage carbon dioxide storage in oyster-based systems, including methods for detecting and recapturing leaked carbon dioxide when sediment mobilization activities occur. No known methods provide a systematic approach for calculating the specific area of cultch material placement needed to recapture a quantified amount of leaked carbon dioxide. Through ingenuity and hard work, the inventors have developed such methods.

### BRIEF SUMMARY

In one aspect, a method for recapturing leaked carbon dioxide from oyster-based carbon storage includes providing cultch material in an aquatic environment suitable for oyster colonization; upon oyster colonization into an oyster colony, measuring oyster density on the cultch material; using an established correlation between oyster density and carbon burial rates, calculating a first carbon dioxide storage rate; measuring an area of the oyster colony and multiplying the area by the first carbon dioxide storage rate to calculate a quantity of carbon dioxide stored in sediments; determining sediment mobilization activities within a predefined distance of the oyster colony; measuring a disturbed area resulting from the sediment mobilization activities and multiplying the disturbed area by a predetermined second carbon dioxide storage rate to provide a quantity of carbon dioxide leakage; calculating a recapture area by dividing the quantity of carbon dioxide leakage by a product of a predetermined carbon burial rate and a recapture time period; and placing additional cultch material in the aquatic environment, wherein a surface area covered by the additional cultch material is at least equal to the recapture area.

In another aspect, a computer-implemented method for managing recapture of leaked carbon dioxide from oyster-based carbon storage includes receiving, by a processor, oyster density measurements from cultch material placed in an aquatic environment; calculating, by the processor using an established correlation between oyster density and carbon burial rates, a first carbon dioxide storage rate; receiving, by the processor, area measurements and multiplying the area by the first carbon dioxide storage rate to calculate a quantity of carbon dioxide stored; determining, by the processor, sediment mobilization activities by monitoring permit databases; receiving, by the processor, measurements of a disturbed area and multiplying the disturbed area by a predetermined second carbon dioxide storage rate to provide a quantity of carbon dioxide leakage; calculating, by the processor, a recapture area; and generating, by the processor, output data indicating a surface area for placement of additional cultch material.

### DETAILED DESCRIPTION

The present disclosure provides systems and methods for carbon capture and storage (CCS) using oyster cultivation, including methods for monitoring, detecting, and recapturing leaked carbon dioxide. The methods involve establishing oyster colonies on cultch material in aquatic environments, measuring carbon dioxide storage through oyster density measurements, detecting sediment mobilization activities that cause leakage, quantifying leaked carbon dioxide, and implementing recapture plans through placement of additional cultch material.

Computer-implemented systems support these methods through mobile device applications for data collection, geographic information system (GIS) software platforms for spatial analysis and calculations, and automated monitoring systems for detecting potential leakage activities.

A first step in the method may comprise placing cultch material in an aquatic environment suitable for oyster colonization. The method is applicable in any environment where oysters can colonize. Suitable environments include bays, estuaries, coastal waters, tidal zones, subtidal zones, intertidal zones, and other marine or brackish water bodies. The aquatic environment may be within commercial shellfish leases, state-owned submerged lands, privately owned aquatic areas, or other legally authorized areas for shellfish cultivation. Suitable salinity ranges typically fall between 5 and 35 parts per thousand, with ranges between 10 and 25 parts per thousand providing optimal conditions for many oyster species. Water temperatures suitable for oyster colonization typically range from 5° C. to 35° C., with temperatures between 15° C. and 28° C. supporting more active growth and carbon capture.

The cultch material may comprise hard substrate suitable for oyster larvae attachment and colonization. Suitable cultch materials include oyster shells, clam shells, mussel shells, other mollusk shells, river rock, limestone, recycled concrete, granite, basalt, artificial reef materials, ceramic materials, and combinations thereof. Shell material may include fresh shells, aged shells, or fossil shells. Recycled concrete must be clean and free of contaminants, with rebar or other metal materials removed. Concrete may be broken or crushed to sizes ranging from 1 inch to 24 inches in diameter. In one implementation, concrete pieces range from 2 inches to 12 inches in diameter. Rock materials may range from gravel-sized (0.25 inches) to boulder-sized (greater than 10 inches). In one implementation, river rock ranges from 2 inches to 8 inches in diameter.

The cultch material is placed on soft substrate (mud, silt, or sand) to create suitable habitat for oyster colonization. Placement density can vary from sparse coverage (10-30% coverage of the bottom) to complete coverage (90-100% coverage). In one implementation, cultch material is placed to achieve 50-80% coverage of the designated area. Thickness of cultch material layers may range from 2 inches to 24 inches. In one implementation, cultch material is placed to a thickness of 4 to 12 inches. In another implementation, cultch material is placed to a thickness of 6 to 10 inches. The surface area covered by initial cultch material placement can vary widely depending on project scale, ranging from less than one acre to hundreds of acres per placement event. Commercial shellfish leases may range in size from less than one acre to over 1000 acres.

Depth of placement for cultch material can vary depending on tidal range, water conditions, and regulatory requirements. Cultch material may be placed at depths ranging from intertidal zones (exposed at low tide) to subtidal zones up to 50 feet deep. In one implementation, cultch material is placed at depths between 2 and 20 feet below mean low water. In another implementation, cultch material is placed at depths between 4 and 12 feet below mean low water.

While this application focuses primarily on the eastern oyster (Crassostaea virginica), the methods are applicable to other oyster species capable of forming reefs and storing carbon in sediments. Suitable oyster species include Crassostrea gigas (Pacific oyster), Crassostrea ariakensis (Suminoe oyster), Ostrea edulis (European flat oyster), Ostrea lurida (Olympia oyster), Saccostrea glomerata (Sydney rock oyster), and other reef-forming bivalves.

In a second step of the method, once oysters have colonized into an oyster colony, the oyster density on the cultch material in the oyster colony is measured. Multiple sampling methods can be employed, including dredge sampling, quadrat sampling, core sampling, and combinations thereof. In dredge sampling, an oyster dredge is towed along the bottom for a measured distance, collecting oysters in a mesh bag. The dredge comprises a steel frame with teeth on the bottom bar and a bag attached to the frame. Dredge dimensions may vary, with widths ranging from 12 inches to 72 inches. In one implementation, the dredge width is 24 to 48 inches. Tow distances may range from 10 feet to 500 feet. In one implementation, tow distances range from 50 to 200 feet. In another implementation, tow distances range from 75 to 150 feet.

The area swept by the dredge is calculated by multiplying the width of the dredge by the tow distance. Tow distance may be recorded using GPS-enabled mobile devices that track the path of the vessel and dredge. The mobile device records a line feature capturing location data and distance. In an embodiment, the software used to measure the tow distance and calculate the dredge area is included as part of the inventive software. Thus, in this embodiment, a user of the inventive software may input a start time and location, optionally by pressing a start button on the software, may dredge the area, and then may input a stop time and location, optionally by pressing the same button or a stop button. The software may then use GPS data to determine the dredge distance. The user may input the width of the dredge into the software and the software may then calculation and, optionally, output the total dredge area.

After retrieval, the contents of the dredge are emptied onto a sorting surface, preferably in a single layer. The software of the invention may interact with a camera on the device and allow the user to take a digital photograph of the oyster contents. This may be conducted on a mobile device application with GPS location and timestamp. Alternatively, the oysters may be counted by hand. All oysters meeting size criteria are counted. Size criteria may specify oysters over 10 mm, 15 mm, 20 mm, 25 mm, or 30 mm in shell length. In one implementation, only oysters over 20 mm in shell length are counted. In an embodiment, the number of dredged oysters is recorded in the GPS-enabled mobile device along with location and time data.

Oyster density is calculated by dividing the count of oysters by the area swept by the dredge. This raw density is then adjusted for gear efficiency. Dredge efficiency factors may range from 5 to 20, meaning the dredge captures only a fraction of oysters in the swept area. In one implementation, the efficiency factor is 10, meaning the count is multiplied by 10 to estimate actual oyster density. In other implementations, efficiency factors of 8, 12, or 15 may be used depending on dredge design, bottom conditions, and tow speed.

Alternative sampling methods may be utilized and may include quadrat sampling, where fixed-area frames (e.g., 0.25 square meters to 4 square meters) are placed on the oyster reef and all oysters within the frame are counted. In one implementation, quadrat frames of 1 square meter are used. Multiple quadrat samples are taken throughout the oyster colony to generate density estimates. The number of quadrat samples may range from 5 to 100 depending on colony size and variability. In one implementation, at least 10 quadrat samples are taken per acre of oyster colony. Any sampling method known in the art is encompassed herein.

Sampling frequency depends on monitoring objectives and regulatory requirements. Initial density measurements may be taken about 6 months to 3 years after cultch material placement. In one implementation, initial measurements are taken 1 to 2 years after placement. Subsequent monitoring may occur annually, biennially, or at other intervals. In one implementation, initial sampling is taken 6 months after cultch placement and oyster density is measured bi-annually.

Sample coverage depends on the size of the oyster colony. For small colonies (less than 5 acres), at least 2 to 5 samples may be taken. For larger colonies, sample density may be specified as a minimum number of samples per unit area. In one implementation, at least one dredge sample is taken per 25 acres. In another implementation, at least one dredge sample is taken per 10 to 50 acres depending on habitat variability. For very large commercial leases (over 100 acres), a minimum of 5 to 10 samples may be specified regardless of total area.

Sampling locations are distributed throughout the oyster colony to capture spatial variability in oyster density. Samples are taken in areas identified as solid reef, in transition areas between reef and non-reef, and in areas containing scattered shell. Sampling locations may be predetermined using a systematic grid pattern, randomly selected, or selected based on benthic characterization data.

Prior to or concurrent with oyster density sampling, the benthic substrate may be characterized to map the spatial extent of oyster habitat. Benthic characterization involves probing the bottom with a pole to determine substrate composition. This process is referred to as “poling.”

During poling, a crew member on a vessel physically probes the bay bottom with a pole and calls out the category corresponding to what they feel. Categories may include: solid reef (pole does not penetrate through hard surface), scattered shell (pole touches a mix of hard and soft substrate), mud (soft unconsolidated material), sand, buried reef (oyster habitat buried by sediment), and other substrate types.

Poling is conducted along transects covering the area to be characterized. The survey vessel proceeds at a controlled speed, typically 1 to 5 miles per hour. In one implementation, the vessel speed is 2 to 4 miles per hour. This speed allows poling points to be spaced at appropriate intervals. Spacing between poling points typically ranges from 5 meters to 50 meters. In one implementation, poling points are spaced approximately 15 meters apart. Spacing between transects typically ranges from 10 meters to 100 meters. In one implementation, transects are spaced no more than 35 meters apart.

In an embodiment, each poling point is recorded in the inventive software using a GPS-enabled mobile device, capturing the location coordinates and substrate category. This data set of points with associated substrate categories may be used for spatial interpolation to generate maps of benthic habitat composition.

In the next step of the invention, a first carbon dioxide storage rate may be calculated using an established correlation between oyster density and carbon burial rates. This correlation is derived from field studies that measured both oyster density and annual carbon burial rates in sediments beneath oyster reefs. Studies have sampled oyster restoration sites and natural reefs using quadrat counts for live oyster density and geological methods (vertical through-reef cores followed by shell and sediment analysis) to quantify annual carbon dioxide sediment storage rates. These studies found strong positive correlations between oyster density and carbon burial rates.

The correlation may be expressed as a mathematical function, such as a linear function, polynomial function, exponential function, logarithmic function, or other regression model. In one implementation, the correlation is modeled using nonlinear regression. The regression model may take the form:

$$Carbon burial rate = a \times {( oyster density )}^{b}$$

where a and b are coefficients determined from empirical data. Alternative functional forms include:

$$Carbon burial rate = a + b \times ( oyster density ) + c \times {( oyster density )}^{2}$$

$$Carbon burial rate = a \times ln ( oyster density + b )$$

In an embodiment, the correlation data and regression coefficients are stored in memory (in computer-implemented systems) or recorded in written form (for manual calculations). Different correlations may be established for different oyster species, geographic regions, or environmental conditions.

Once oyster density is measured for a location or area, the established correlation is applied to calculate the carbon dioxide storage rate. The storage rate is typically expressed in units of metric tons of carbon dioxide per acre per year, but may also be expressed in metric tons per hectare per year, grams per square meter per year, or other units.

For example, if a dredge sample yields a count of 50 oysters over an area of 100 square feet (0.0023 acres), and an efficiency factor of 10 is applied, the estimated oyster density is (50×10)/0.0023 acres=217,391 oysters per acre. Applying a stored correlation function to this density value yields a carbon dioxide storage rate for that location.

Multiple density measurements throughout an oyster colony result in multiple storage rate calculations. These storage rates may be averaged, weighted by sample area, or spatially interpolated to generate storage rate maps for the entire colony.

The total quantity of carbon dioxide stored in an oyster colony is calculated by multiplying the carbon dioxide storage rate by the area of the oyster colony and by the time period of storage. For annual storage calculations:

$$Total {CO}_{2} stored ( metric tons ) = Storage rate ( metric tons / acre / year ) \times Area ( acres ) \times Time ( years )$$

For oyster colonies with spatially variable density and storage rates, the colony may be divided into zones or categories based on oyster density ranges. For example, zones may be defined as:
High density: greater than 150,000 oysters per acre
Medium density: 50,000 to 150,000 oysters per acre
Low density: 10,000 to 50,000 oysters per acre
Scattered: less than 10,000 oysters per acre

Alternative density categories may use different thresholds, such as greater than 200,000, 100,000 to 200,000, 25,000 to 100,000, and less than 25,000 oysters per acre. Each density zone has an associated carbon dioxide storage rate calculated from the correlation function. The total carbon dioxide stored is calculated by summing the products of storage rate, area, and time for each zone:

Total CO₂ stored=Σ(Storage rateᵢ×Areaᵢ×Time), where i represents each density zone.

The gross carbon dioxide storage calculated above may be adjusted to account for emissions and losses. Adjustments may include deductions for:

Net ecosystem metabolism: Carbon dioxide released through heterotrophic respiration in sediments beneath oyster reefs. This deduction may range from 1 to 5 metric tons CO₂ per acre per year. In one implementation, 2.57 metric tons CO2 per acre per year is deducted for net ecosystem metabolism.

Biomineralization emissions: Carbon dioxide released during precipitation of calcium carbonate in oyster shells. Due to the buffering effect of seawater, a portion of the carbon stored as calcium carbonate results in CO₂ release. This deduction may range from 30% to 60% of the carbon dioxide stored as calcium carbonate. In one implementation, 43% of the CO₂ stored as calcium carbonate is deducted for biomineralization emissions.

Project emissions: Carbon dioxide emitted by equipment used to transport cultch material and conduct monitoring activities. These emissions are calculated using emission factors for fuel consumption.

The net carbon dioxide stored is calculated by subtracting these emissions from the gross carbon dioxide stored. The following equations define the complete mass balance calculation for determining net carbon dioxide storage:

$$Net total annual {CO}_{2} \qquad Equation 1$$

$${CO}_{2} = {CO}_{2} S - {CO}_{2} L - {CO}_{2} RB - {CO}_{2} E$$

Where:
CO₂=Net total annual CO₂ mass (metric tons) geologically stored within the Commercial Oyster Leases
CO₂S=Total annual CO₂ mass (metric tons) stored
CO₂L=Total annual CO₂ mass emitted (metric tons) by leakage
CO₂RB=Total annual CO₂ mass emitted (metric tons) by Respiration and Biomineralization
CO₂E=Total annual CO₂ mass emitted (metric tons) by Equipment

$$Total annual {CO}_{2} mass stored \qquad Equation 2$$

$${CO}_{2} S = \sum ( {CO}_{2} \times B \times SAx )$$

Where:
CO₂S=Total annual CO₂ mass (metric tons) stored
CO₂xB=Annual CO₂ Burial Rate (metric tons·acre⁻¹·yr⁻¹) determined using adult oyster density measurements
SAx=Total Surface Area (acres) for the adult oyster densities sampled
n=The number of adult oyster density zones sampled

$$Total annual {CO}_{2} mass leaked \qquad Equation 3$$

$${CO}_{2} L = \sum ( {CO}_{2} yP \times SAD \times yr )$$

Where:
CO₂L=Total annual CO₂ mass emitted (metric tons) by leakage
CO₂yP=Annual CO₂ Burial Rate (metric tons·acre⁻¹·yr⁻¹) reported in previous years for the area of disturbance
SAD=Area of Disturbance (acres)
yr=Year that an annual CO₂ mass was measured and reported for the disturbed area

$$Total annual {CO}_{2} mass emitted from Respiration and Biomineralization \qquad Equation 4$$

$${CO}_{2} RB = \sum [ ( NEM \times SAx ) + ( {CO}_{2} \times IBE ) ]$$

Where:
CO₂RB=Total annual CO₂ mass emitted (metric tons) by Respiration and Biomineralization
NEM=Net Ecosystem Metabolism (metric tons·acre⁻¹·yr⁻¹), typically −2.57 metric tons·acre⁻¹·yr⁻¹
SAx=Total Surface Area (acres) for the adult oyster densities sampled
CO₂xIBE=Total annual CO₂ mass emitted (metric tons) resulting from Biomineralization of CaCO₃

$$Total annual {CO}_{2} mass emitted by {equipment}^{**} \qquad Equation 5$$

$${CO}_{2} E = \sum [ EFt ( CW \times CDt ) + EFw ( CW \times CDw ) ]$$

Where:
CO₂E=Total annual CO₂ mass emitted (metric tons) by Equipment
EFt=GHG “truck” emission factor (ton-mile basis)
EFw=GHG “waterborne craft” emission factor (ton-mile basis)
CW=Cultch Weight (metric tons)
CDt=Cultch Truck Transportation Distance (miles)
CDw=Cultch Waterborne Transportation Distance (miles)

$$Combined Annual {CO}_{2} mass geologically stored \qquad Equation 6$$

$${CO}_{2} \times B = \sum ( {CO}_{2} ly + {CO}_{2} Oy )$$

Where:
CO₂xB=Annual CO₂ burial rate (metric tons·acre⁻¹·yr⁻¹) determined using adult oyster density measurements
CO₂Iy=Total annual CO₂ mass (metric tons) geologically stored in the form of inorganic carbon (e.g., shell and CaCO₃) within each commercial shellfish lease
CO₂Oy=Total annual CO₂ mass (metric tons) geologically stored in the form of organic carbon (e.g., detritus, feces, pseudofeces) within each commercial shellfish lease
n=Number of participating commercial shellfish leases

$$Total annual {CO}_{2} mass emitted from Biomineralization \qquad Equation 7$$

$${CO}_{2} \times IBE = \sum ( {CO}_{2} ly ) \times 0.43$$

Where:
CO₂xIBE=Total annual CO₂ mass emitted (metric tons) resulting from Biomineralization of CaCO₃

CO₂Iy=Total annual CO₂ mass (metric tons) geologically stored in the form of inorganic carbon

n=Number of participating commercial shellfish leases

0.43=stoichiometric factor representing 43% of the mass of CO₂ stored as CaCO₃ potentially released from biomineralization

$$Oyster density adjusted for gear efficiency \qquad Equation 8$$

$$N = q \times n s$$

Where:
N=Oyster Abundance (adjusted density)
q=catchability coefficient

ns=survey catch (raw count from dredge or sampling gear)

$$Catchability Coefficient \qquad Equation 9$$

$$q = A / ( d w \times e )$$

Where:
q=catchability coefficient
A=area surveyed
dw=swept area (distance towed×dredge inside width)
e=efficiency of capture of the dredge

$$Simplified Oyster density calculation \qquad Equation 10$$

$$N = ( 1 / e ) \times n s$$

Where:
N=Oyster Abundance (adjusted density)
e=efficiency of capture of the dredge (typically 0.1 or 10%)
n=survey catch (raw count)

$$Adjusted Survey Count for all Age Classes \qquad Equation 11$$

$$n s = N A / P f$$

Where:
n=adjusted survey catch (total for all age classes)
NA=adult oyster count from a sample
Pf=proportionality factor of average adult oysters to total oysters (all age classes)

$$Proportionality factor \qquad Equation 12$$

$$P f = 1 / P a$$

Where:
Pf=proportionality factor of average adult oysters to total oysters
Pa=average proportion of samples that are adult oysters

$$Published average for adult oyster proportionality \qquad Equation 13$$

$$P a = \sum ( AOr / TOr ) / R$$

Where:
Pa=average proportion of samples that are adult oysters
AOr=Average number of Adult Oysters per sample
TOr=Total average number of oysters (all age classes)
R=number of reefs or sampled areas with average oyster densities by length or age in a study

$$Recapture Area Calculation \qquad Equation 14$$

$$Recapture Area = {CO}_{2} L / ( Carbon Burial Rate \times Recapture Period )$$

Where:
Recapture Area=surface area (acres) requiring additional cultch material placement
CO₂L=Total leaked CO₂ (metric tons)

Carbon Burial Rate=predetermined rate (metric tons·acre⁻¹·yr⁻¹), typically 5 metric tons·acre⁻¹·yr⁻¹

Recapture Period=time period for recapture (years), typically 3 years

In the next step of the invention, sediment mobilization activities within a predefined distance of the oyster colony may be identified. To detect activities that may cause leakage of stored carbon dioxide, a monitoring area is defined around each oyster colony. The monitoring area extends a predefined distance from the oyster colony boundary in all directions. The predefined distance may range from 100 feet to 10 miles depending on the scale of potential disturbance activities, regulatory requirements, and monitoring resources. In various implementations, the predefined distance is 500 feet, 1000 feet, 0.25 miles, 0.5 miles, 1 mile, 2 miles, or 5 miles. In one implementation, the predefined distance is at least 1 mile from the oyster colony boundary. In another implementation, the predefined distance is 1 mile circumferentially from the boundary of a commercial shellfish lease containing the oyster colony. The monitoring area may be limited to aquatic areas or may extend to adjacent land areas where construction activities could affect sediment stability in the aquatic environment.

Multiple methods may be used to detect sediment mobilization activities within the monitoring area. Commercial shellfish leaseholders continuously monitor the status of their leases during routine operations. Leaseholders are well-positioned to observe changes in bottom conditions, debris, or disturbance activities. Participating leaseholders are required or encouraged to report potential leakage events as soon as safely possible. In some cases, the leaseholders may fill out a questionnaire providing the relevant information or may report it at an annual meeting. Thus, in an embodiment, sediment mobilization activities are identified based upon information provided by a commercial shellfish leaseholder.

In another embodiment, permit databases are searched for authorized construction activities within the monitoring area. This may be conducted by a human or automatically through the inventive software. Permit databases may include federal, State, and local regulatory databases. Examples include the U.S. Army Corps of Engineers (USACE) Permit Finder web application, State environmental protection databases, State coastal zone management databases, and local building permit databases. Database searches may be conducted annually, quarterly, monthly, or in real-time depending on available technology and monitoring resources. Search parameters include geographic coordinates defining the monitoring area and activity types that may cause sediment mobilization. Activity types include dredging, excavation, pipeline installation, oil and gas well construction, navigation channel construction, vessel grounding, dock construction, bridge construction, and other activities involving bottom disturbance.

In yet another embodiment, satellite imagery, aerial photography, or drone-based imaging may be used to detect changes in water turbidity, bottom features, or

construction activities within the monitoring area. Any method known in the art may be utilized to detect sediment mobilization activities within the monitoring area.

The types of sediment mobilization activities that could be relevant include dredging for navigation channels, beach nourishment, or resource extraction, excavation for pipeline installation (oil, gas, water, telecommunications), construction of oil and gas wells, platforms, or facilities, installation of offshore wind energy facilities, construction of docks, piers, or marinas, construction or expansion of bridges with in-water pile driving, accidental vessel groundings, anchor dragging, trawling or other fishing activities, construction of coastal armoring (seawalls, revetments), or any other activity involving mechanical disturbance of the benthos.

In the next step of the invention, upon detection of a sediment mobilization activity, the disturbed area is identified and delineated. The disturbed area comprises the footprint directly impacted by the activity where sediments have been mobilized, removed, or significantly altered. For permitted activities, the disturbed area may be defined by permit documents specifying the work area, dredge footprint, or excavation boundaries. For unpermitted or accidental events (e.g., vessel grounding), the disturbed area may be identified through field investigation. Field investigation involves visiting the site and identifying visible changes in bottom conditions or “poling” as described above. The area of disturbance is marked with poles, buoys, or GPS coordinates. Activities that mobilize sediment typically result in a change in depth and benthos composition. The area of disturbance is identified by probing the bottom with a pole to identify changes in depth or substrate composition.

In an embodiment, the boundary of the disturbed area is recorded using the inventive software and a GPS-enabled mobile device. Multiple GPS coordinates may be collected around the perimeter of the disturbed area to define a polygon representing the disturbed footprint. The surface area of the disturbed region is then calculated from the GPS coordinates defining the disturbed area boundary. GIS software is used to generate a polygon from the GPS points and calculate the enclosed area. The area may be calculated in acres, hectares, square feet, square meters, or other units.

In some implementations, a buffer zone is added around the directly disturbed area to account for indirect effects on adjacent sediments. The buffer width may range from 0 feet to 100 feet. In one implementation, a buffer zone of 10 feet (approximately 3 meters) is added around the perimeter of the directly disturbed area. In another implementation, buffer zones of 5, 15, 20, or 30 feet are used depending on the nature of the disturbance activity. The total disturbed area for leakage calculations includes the directly disturbed area plus the buffer zone area.

To calculate the quantity of leaked carbon dioxide, the carbon dioxide storage rate for the disturbed area must be determined. In one implementation, this second carbon dioxide storage rate is the same as the first carbon dioxide storage rate calculated for the oyster colony. This approach assumes uniform carbon storage throughout the colony. In another implementation, the second carbon dioxide storage rate is different from the first carbon dioxide storage rate and is specifically calculated for the disturbed area based on historical measurements or spatial interpolation. GIS software is used to overlay the disturbed area polygon with previously measured and mapped carbon storage data for the oyster colony. If the disturbed area falls within a zone of known oyster density and carbon storage rate, that specific storage rate is used for leakage calculations.

For example, if previous sampling and analysis determined that a particular portion of an oyster colony has a carbon dioxide storage rate of 8 metric tons per acre per year, and a disturbance occurs within that portion, the 8 metric tons per acre per year rate is used as the second carbon dioxide storage rate for that disturbance. If no site-specific storage rate data exists for the disturbed area, alternative approaches include using the average storage rate for the entire colony, using a conservative (high) storage rate to avoid underestimating leakage, or conducting new sampling in the disturbed area if undisturbed sediments remain.

The quantity of carbon dioxide leakage is then calculated by multiplying the disturbed area by the second carbon dioxide storage rate and by the duration of storage prior to the disturbance event:

CO₂ leakage (metric tons)=Disturbed area (acres)×Second CO₂ storage rate (metric tons/acre/year)×Storage duration (years)

For example, if a disturbance affects 0.5 acres of an oyster colony that had been storing carbon for 3 years at a rate of 6 metric tons per acre per year, the quantity of leaked CO₂ is:

0.5 acres×6 metric tons/acre/year×3 years=9 metric tons CO₂

This calculation provides an estimate of the total carbon dioxide that was stored in sediments within the disturbed area and is now considered leaked due to sediment mobilization.

This calculation is conservative in that it assumes all stored carbon dioxide is returned to the atmosphere, when in reality some sediments may resettle locally and remain buried, some carbon may be captured by primary producers before re-entering the atmosphere, and some may be recaptured by oysters in adjacent areas of the colony that were not disturbed.

In some embodiments, the calculated quantity of carbon dioxide leakage is certified through a verification process. Verification may involve review by independent third parties, submission to regulatory authorities, or documentation according to carbon credit program standards. GIS software generates reports certifying the quantified leakage amounts, including maps showing the disturbed area, calculations showing the methodology, and supporting data including GPS coordinates, sampling results, and storage rate determinations.

Upon quantification of leaked carbon dioxide, a recapture area is then calculated to determine the surface area of additional cultch material placement needed to recapture the leaked carbon dioxide over a specified time period.

The recapture area is calculated by dividing the quantity of carbon dioxide leakage by the product of a predetermined carbon burial rate and a recapture time period:

Recapture area (acres)=CO2 leakage (metric tons)/[Predetermined carbon burial rate (metric tons/acre/year)×Recapture time period (years)]

The predetermined carbon burial rate represents the expected carbon storage rate for newly established oyster colonies on cultch material. This rate may be based on average storage rates observed in similar environments, conservative estimates to ensure successful recapture, or regulatory requirements. The predetermined carbon burial rate may range from 2 to 10 metric tons per acre per year. In one implementation, the predetermined carbon burial rate is 5 metric tons of carbon dioxide per acre per year. In other implementations, rates of 3, 4, 6, or 7 metric tons per acre per year may be used.

The recapture time period represents the duration over which the recapture is expected to occur and be verified. The recapture time period may range from 1 to 10 years. In one implementation, the recapture time period is 3 years. In other implementations, recapture time periods of 2, 4, 5, or 7 years may be used. Longer recapture periods allow for more gradual oyster colonization and reduce the required recapture area, while shorter periods provide faster restoration but require larger recapture areas.

For example, using the previous leakage example of 9 metric tons CO₂, a predetermined carbon burial rate of 5 metric tons per acre per year, and a recapture time period of 3 years:
Recapture area=9 metric tons/(5 metric tons/acre/year×3 years)=0.6 acres.

As a complete working example: An oyster colony on a 10-acre commercial lease in Mobile Bay, Alabama was sampled using three dredge tows. Tow 1 collected 45 oysters over a swept area of 120 square feet (0.00275 acres), yielding density of (45×10)/0.00275=163,636 oysters/acre. Applying a nonlinear regression correlation with coefficients a=0.0003 and b=0.85 stored in the system: Storage rate=0.0003×(163,636)\hat{ }0.85=6.2 metric tons CO2/acre/year. Similarly, Tow 2 yielded 120,000 oysters/acre (4.8 metric tons/acre/year) and Tow 3 yielded 200,000 oysters/acre (7.8 metric tons/acre/year). GIS analysis determined 4 acres in high-density zone (7.8 metric tons/acre/year), 4 acres in medium-density (6.2 metric tons/acre/year), and 2 acres in low-density (4.8 metric tons/acre/year). Total annual CO2 stored=(4×7.8)+(4×6.2)+(2×4.8)=65.6 metric tons/year. After 2 years of operation, a pipeline installation disturbed 0.5 acres in the medium-density zone. Leaked CO2=0.5 acres×6.2 metric tons/acre/year×2 years=6.2 metric tons. Recapture area=6.2/(5×3)=0.41 acres. The system generated output recommending placement of cultch material covering 0.5 acres (including 20% safety margin) within or adjacent to the disturbed area.

In an embodiment, the invention additionally comprises determining a location for placing additional cultch material. In this embodiment, the location is selected based on multiple factors including proximity to the disturbed area, suitability of benthic conditions, water quality parameters, regulatory restrictions, and logistical considerations. In one implementation, the additional cultch material is placed within or immediately adjacent to the disturbed area to restore the area where leakage occurred. In another implementation, the additional cultch material is placed in a different location within the same commercial shellfish lease or within a nearby lease operated by the same entity.

Site selection considers bottom substrate (soft substrate is suitable for cultch placement), water depth (within ranges suitable for oyster colonization), salinity (within optimal ranges for the oyster species), water flow (sufficient for food supply and waste removal), and absence of conflicting uses (navigation channels, utility corridors).

Additional cultch material is placed in the aquatic environment covering a surface area at least equal to the calculated recapture area. The surface area covered by additional cultch material placement may exceed the recapture area to provide a margin of safety or to account for potential variability in colonization success. In various implementations, the placement area is 100% to 150% of the calculated recapture area. In one implementation, the placement area is 100% to 120% of the calculated recapture area.

The types, sizes, and placement methods for additional cultch material are the same as described previously for initial cultch material placement. Placement may be accomplished using barges, workboats, or other vessels equipped for handling and distributing shell, rock, or concrete materials. Materials may be spread using hydraulic equipment, conveyor systems, or manual distribution.

In an embodiment, placement is documented using GPS-enabled mobile devices to record the boundaries of the placement area, the date and time of placement, and the estimated volume or mass of cultch material placed. Photographs may be taken before, during, and after placement to document conditions and placement coverage.

Following placement of additional cultch material, the recapture area is monitored to verify that oyster colonization occurs and that carbon dioxide storage goals are being achieved. Monitoring involves measuring oyster density on the additional cultch material using the same methods described previously for measuring oyster density. Monitoring frequency during the recapture period may be more frequent than routine monitoring. In one implementation, oyster density is measured annually over the recapture period. For a 3-year recapture period, measurements may be taken at year 1, year 2, and year 3 after placement.

As discussed herein, computer-implemented systems may be utilized for managing carbon dioxide storage monitoring and recapture comprise one or more computing devices configured to execute software applications and perform calculations. The system architecture may include mobile computing devices, servers, cloud-based computing resources, and networking infrastructure connecting these components.

In an embodiment, the system includes mobile devices (e.g., smartphones, tablets, ruggedized field devices) used by field personnel to collect data. Mobile devices may execute mobile device applications and may include GPS receivers for location tracking, cameras for capturing georeferenced photographs, and wireless communication interfaces for transmitting data. The system may include one or more servers that receive data from mobile devices, store data in databases, execute analytical software, and generate reports and outputs. Servers may be physical servers located at a facility or virtual servers running on cloud computing platforms (e.g., Amazon Web Services, Microsoft Azure, Google Cloud). The system may include remote computing devices (e.g., desktop computers, laptops) used to access data, perform analyses, generate maps, and produce reports. Remote computing devices may execute GIS software, data analysis software, and web browsers for accessing server-based applications. The system may, in an embodiment, include external data sources such as permit databases (e.g., USACE Permit Finder), weather data services, tide data services, and water quality databases. Servers may be configured to query external data sources to retrieve relevant information. Components of the system may communicate via network, which may include the Internet, cellular data networks, Wi-Fi networks, satellite communication networks, or combinations thereof.

Each computing device in the system may comprise hardware components including at least one processor, memory, storage, and input/output interfaces. The processor executes instructions stored in memory to perform computing operations. The processor may comprise a central processing unit (CPU), graphics processing unit (GPU), application-specific integrated circuit (ASIC), field-programmable gate array (FPGA), or other processing hardware. Memory includes volatile memory such as random access memory (RAM) used for temporary storage of data and instructions during operation. Memory capacity may range from 1 GB to 128 GB or more depending on the device and application requirements. Storage includes non-volatile storage such as solid-state drives (SSD), hard disk drives (HDD), or flash memory used for persistent storage of software, data, and files. Storage capacity may range from 16 GB to 10 TB or more depending on the device and data storage requirements. Input/output interfaces include network interfaces (Ethernet, Wi-Fi, cellular), display interfaces (HDMI, DisplayPort), USB interfaces, and other interfaces for connecting peripherals and communicating with other devices.

The disclosed computer systems solve specific technical problems arising in carbon storage monitoring. A first technical problem is spatial data synchronization across distributed field teams. When multiple mobile devices simultaneously collect GPS-tagged data across different areas, conventional database systems experience conflicts when concurrent users create overlapping or duplicate spatial features. The disclosed system solves this by implementing spatial conflict detection logic that compares geometries of incoming features against existing features using spatial predicates (ST_Intersects, ST_Within), flags potential conflicts when samples are within a proximity threshold (e.g., 10 meters), and queues flagged records for administrative review rather than rejecting submissions or performing automatic merging that could corrupt data.

A second technical problem is computational efficiency of polygon overlay operations. Calculating leaked CO2 requires overlaying a disturbance polygon with potentially hundreds of carbon storage zone polygons, each containing complex geometries with hundreds to thousands of vertices. Naïve polygon intersection algorithms that compare every vertex of one polygon with every edge of another polygon have O(n×m) computational complexity. The disclosed system solves this through a two-stage filtering process: (1) spatial index filtering using bounding box comparisons executes in O(log k) time where k is total number of zones, identifying candidate zones whose bounding boxes intersect the disturbance polygon; (2) precise geometry intersection computation using optimized computational geometry libraries (e.g., GEOS library implementing sweep line algorithms) executes only for candidate zones. This reduces computation time from hours to seconds for large datasets.

A third technical problem is GPS accuracy assessment during mobile data collection. Mobile devices report GPS coordinates even when satellite geometry is poor, resulting in inaccurate location data that corrupts spatial analysis. The disclosed system solves this by the mobile application continuously reading HDOP (Horizontal Dilution of Precision) and accuracy estimate values from the GPS receiver via operating system location services APIs, comparing real-time HDOP values against threshold values (e.g., HDOP>5 indicates poor accuracy) stored in application configuration, displaying real-time accuracy indicators to users through the user interface, and automatically flagging collected data points with metadata indicating low GPS quality for subsequent filtering during analysis.

Mobile devices may additionally include GPS receivers capable of determining geographic coordinates with accuracy ranging from 1 meter to 50 meters depending on receiver quality and environmental conditions. High-precision GPS receivers capable of sub-meter or centimeter-level accuracy may be used for applications requiring precise location data. Mobile devices may additionally include cameras for capturing digital photographs or video. Cameras may have resolutions ranging from 5 megapixels to 50 megapixels or higher. Captured images are automatically tagged with GPS coordinates, timestamps, and other metadata.

The mobile device application may comprise software executed by the processor of the mobile device to collect field data related to oyster density measurements, benthic characterization, and disturbance detection. The mobile device application may provide user interfaces for data entry and automated data collection from device sensors. The mobile device application may be configured to record sampling events including location coordinates from GPS receiver, timestamps from device clock, and measurement data entered by user or automatically collected. For dredge sampling events, the application records a line feature (polyline) representing the tow path by continuously recording GPS coordinates during the tow. The application calculates tow distance from the GPS coordinates along the polyline. For each sampling event, the application may prompt user to enter oyster count, substrate type, water depth, or other relevant parameters. The application may provide selection menus, numeric input fields, or voice input capabilities for data entry. The application may be configured to capture digital photographs using camera and automatically associate each photograph with GPS location coordinates, timestamp, and the related sampling event. Photographs may be used to document bottom conditions, dredge contents, or disturbance areas.

The mobile device application interfaces with GPS receiver hardware through operating system-specific location services APIs. On iOS devices, the application utilizes the Core Location framework by instantiating a CLLocationManager object, setting the desiredAccuracy property to kCLLocationAccuracyBest (which requests GPS-level accuracy rather than lower-accuracy WiFi or cellular positioning), setting the distanceFilter property to 1.0 meter (causing location updates only when device moves at least 1 meter), and registering as a delegate to receive location update callbacks. On Android devices, the application utilizes Google Play Location Services by creating a LocationRequest object with priority set to PRIORITY\_HIGH\_ACCURACY and smallest displacement set to 1.0 meter. When location updates are received, the application extracts latitude (decimal degrees), longitude (decimal degrees), altitude (meters), horizontal accuracy (meters), speed (meters/second), timestamp (UTC), and when available, HDOP value from satellite data. These values are stored in memory structures and used for real-time display, data validation, and persistent storage.

The application may store collected data in local storage of mobile device and uploads data to a server via a network when connectivity is available. Upload may occur in real-time during data collection if cellular or Wi-Fi connectivity is available, or may occur in batch mode when device later connects to network. Data is uploaded to cloud-based storage (e.g., ESRI ArcGIS Online servers) or to dedicated project servers. The application may provide offline functionality allowing data collection to continue when network connectivity is unavailable. Collected data is stored locally and automatically uploaded when connectivity is restored. The application may provide quality control features such as validation of entered data (e.g., checking that numeric values are within reasonable ranges), prompting user to complete all required fields, and flagging anomalous measurements for review.

Data collected by the mobile device application may be transmitted to and stored in databases on servers. Databases may comprise structured databases (e.g., relational databases using SQL) or unstructured databases (e.g., NoSQL databases) suitable for storing geospatial data, time-series data, and associated metadata. In one implementation, data is stored using ESRI ArcGIS geodatabase formats optimized for geospatial data. Each sampling event is stored as a feature with associated geometry (point for quadrat samples, polyline for dredge tows, polygon for disturbed areas) and attribute data (oyster count, timestamp, substrate type, etc.). Data is stored in an unmodified state preserving original field measurements for verification and audit purposes. Calculated values (adjusted densities, storage rates, leakage quantities) are stored separately from raw field measurements with clear documentation of calculation methods and parameters used.

In one implementation, the database schema includes specialized data structures for storing geospatial-temporal carbon storage data. A SamplingEvent table stores records with fields including: EventID (unique identifier), EventType (enumerated: “dredge\_tow”, “quadrat”, “poling”), EventTimestamp, UserID, GeometryType, and GeometryData. For dredge tow events, GeometryData comprises a polyline stored as an ordered array of coordinate pairs in a specified coordinate reference system (e.g., WGS84 or UTM). An OysterDensity table stores fields including: DensityID, EventID (foreign key), RawCount (integer), SweptArea (decimal), EfficiencyFactor (decimal), AdjustedDensity (calculated as RawCount×EfficiencyFactor/SweptArea), and CalculationTimestamp. A CarbonStorageZone table stores fields including: ZoneID, LeaseID, ZoneGeometry (polygon), DensityCategory (enumerated), MeasuredDensity, CalculatedStorageRate, and CalculationDate. A DisturbanceEvent table stores fields including: DisturbanceID, DetectionDate, DisturbanceGeometry (polygon), BufferDistance, TotalDisturbedArea, and PermitReference. A LeakageCalculation table stores fields including: LeakageID, DisturbanceID, AffectedZoneID (foreign key), IntersectionArea, ApplicableStorageRate, StorageDuration, and CalculatedLeakage. Spatial indexes using R-tree structures are created on geometry fields to enable efficient spatial queries.

Databases may store historical data allowing analysis of trends over time, comparison of current measurements to previous measurements, and retrieval of storage rate data for disturbed areas based on previous sampling at those locations. Access controls may limit who can view, modify, or delete data. Field personnel may have permission to add new data but not modify or delete existing data. Analysts may have permission to perform calculations and generate reports. Administrators may have full permissions including data modification and deletion.

GIS software may be executed on servers or remote computing devices performs spatial analysis and generates maps. GIS software may comprise ESRI ArcGIS, QGIS, MapInfo, or other geospatial analysis platforms. The GIS software performs interpolation of benthic characteristics from discrete poling point measurements to generate continuous surfaces or classified polygon layers. Interpolation methods include inverse distance weighting (IDW), kriging, spline interpolation, or other spatial interpolation algorithms. In inverse distance weighting, the value at an unmeasured location is estimated as a weighted average of values at nearby measured points, with weights inversely proportional to distance. The power parameter for IDW may range from 1 to 5. In one implementation, an IDW power parameter of 2 is used. The search radius for including nearby points may range from 10 meters to 500 meters depending on point density and spatial variability.

The processor executes the inverse distance weighting interpolation algorithm as follows: For each unmeasured location (x, y) where substrate type is to be predicted: (1) query the spatial index to identify all poling points within search radius R (e.g., 50 meters) of location (x, y); (2) for each identified point i with known substrate category zi at location (xi, yi), calculate Euclidean distance di=sqrt((x−xi)²+(y−yi)₂); (3) calculate weight wi=1/(di\hat{ }p), where p is a power parameter stored in configuration (typically 2); (4) calculate weighted average z=Σ(wi×zi)/Σ(wi) where the sum is over all identified points; (5) classify the calculated value z into a discrete substrate category based on threshold values stored in configuration tables. This algorithm is executed for each cell in a raster grid covering the oyster colony area, with cell resolution ranging from 1 meter to 10 meters. The use of spatial indexes reduces computational complexity from O(n) for linear search to O(log n) for each interpolation point, where n is the total number of poling points.

The GIS software may correlate oyster density measurements from dredge tow locations with interpolated benthic characteristics to assign oyster densities to different substrate types or zones. The software may calculate the area swept by each dredge tow from the recorded polyline and dredge width. Oyster density may be calculated for each tow and associated with the centroid location of the tow or with the substrate types encountered during the tow. The GIS software may generates polygons representing zones of similar oyster density or substrate type within an oyster colony. Polygons may be generated by classifying the interpolated continuous surface into discrete categories (e.g., high, medium, low density zones) or by dissolving adjacent areas with similar characteristics.

Servers may execute analytical software comprising instructions that cause processors to perform calculations related to carbon dioxide storage and leakage. The analytical software may be integrated within the GIS software, may be separate specialized software, or may comprise scripts or programs written in Python, R, JavaScript, or other programming languages. The analytical software receives oyster density measurements from the databases. For dredge-based measurements, the software retrieves oyster counts, swept areas from GPS tow paths, and applies gear efficiency factors to calculate adjusted oyster densities. Efficiency factors are stored in configuration files or database tables and may be updated based on calibration studies. The analytical software applies the established correlation between oyster density and carbon burial rates. The correlation function and associated coefficients are stored in memory or in configuration files. The software evaluates the correlation function for each measured oyster density to calculate a carbon dioxide storage rate.

For spatial analysis, the software may associate calculated storage rates with their corresponding locations or zones. The software may calculate total carbon dioxide stored by multiplying storage rates by zone areas and by time periods. The software may sum storage quantities across all zones to calculate total carbon dioxide stored in an oyster colony. The analytical software may calculate quantities of leaked carbon dioxide by multiplying disturbed area measurements by carbon dioxide storage rates and storage durations as previously described. The software retrieves storage rate data for disturbed area locations from historical data in the databases or from current spatial analysis results.

The correlation coefficients are derived from empirical field studies that measure both oyster density and carbon burial rates at specific locations. For example, studies conducted in Gulf Coast estuaries have yielded coefficients of approximately a=0.0003 and b=0.85 for the function: Carbon burial rate=a×(oyster density)\hat{ }b. A person of ordinary skill in the art can establish site-specific correlations by conducting field sampling to measure oyster densities using the methods described herein, collecting sediment cores at the same locations, analyzing cores for carbon content and deposition rates using standard geological and geochemical methods, and performing nonlinear regression analysis to fit the density and burial rate data. Alternatively, published correlations from similar geographic regions, oyster species, and environmental conditions may be used when site-specific data is not available. Once established, the correlation coefficients are stored in the system memory or database for repeated application to new density measurements.

The analytical software may calculate recapture areas by dividing leaked carbon dioxide quantities by predetermined carbon burial rates and recapture time periods. Predetermined carbon burial rates and recapture time periods may be stored as configuration parameters that can be adjusted by system administrators. The analytical software applies emissions adjustments by deducting net ecosystem metabolism, biomineralization emissions, and project emissions from gross carbon dioxide storage calculations. Emission factors and deduction percentages are stored as configurable parameters. The software restricts calculated carbon storage to within defined geographical boundaries of commercial leases, project areas, or other specified boundaries. This is accomplished by clipping or masking analysis results to boundary polygons. Calculations of total area or total carbon storage only include areas within the specified boundaries.

The GIS software may calculates surface areas for generated polygons (density zones, disturbed areas, recapture areas) in desired units (acres, hectares, square meters). Area calculations account for map projection and coordinate system to provide accurate measurements. The GIS software may perform overlay analysis to determine the intersection of disturbed area polygons with previously mapped carbon storage zones. This overlay analysis identifies which portions of the oyster colony were disturbed and retrieves the associated carbon storage rates for those portions. The software calculates the area of intersection polygons and multiplies by storage rates to quantify leaked carbon dioxide.

The system includes automated monitoring functionality for detecting sediment mobilization activities. Servers may execute monitoring software that periodically queries external data sources such as permit databases to identify new or pending permits within monitoring areas around oyster colonies. The monitoring software defines monitoring area boundaries based on oyster colony boundaries (stored as polygons in the databases) and predefined buffer distances (stored as configuration parameters). The software generates buffer polygons around colony boundaries using GIS functions. The monitoring software constructs query parameters for external databases including geographic coordinates defining monitoring area boundaries and activity type keywords (e.g., “dredging”, “excavation”, “pipeline”). The software submits queries to external databases via application programming interfaces (APIs), web scraping, or manual database downloads depending on available access methods. For databases providing API access, the monitoring software sends HTTP requests with query parameters and receives responses in structured formats (e.g., JSON, XML). The software parses responses to extract permit information including permit applicant, activity description, location coordinates, permitted work area boundaries, and permit status.

The monitoring software may compare permit locations to monitoring area boundaries using spatial analysis functions. If a permit location falls within a monitoring area boundary, the software flags the permit for review. Flagged permits are stored in the databases and presented to users through alert notifications or report dashboards. The monitoring software may execute on a scheduled basis (e.g., daily, weekly, monthly) using job scheduling systems (e.g., cron, Windows Task Scheduler) or cloud-based scheduling services. In one implementation, the monitoring software queries permit databases annually before the end of each calendar year. In another implementation, queries are performed monthly or quarterly to provide more timely detection. The monitoring software may generate automated notifications (e.g., email, text message, application push notification) to alert personnel when potential disturbance activities are detected. Notifications include summary information about the detected permit and links to view detailed information.

The system may generate reports and visualizations presenting carbon dioxide storage data, monitoring results, leakage calculations, and recapture plans. Report generation software executing on servers or remote computing devices retrieves data from the databases, performs calculations if needed, and formats results into reports. Reports may include textual summaries, tables of data, charts and graphs, and maps. Report formats include PDF documents, web pages (HTML), Microsoft Word documents, Microsoft Excel spreadsheets, or other formats suitable for distribution and archiving. The system generates geospatial maps displaying oyster colony areas with associated carbon dioxide storage quantities, disturbed areas with associated carbon dioxide leakage quantities, and recommended locations for placement of additional cultch material corresponding to calculated recapture areas. Maps include base layers (aerial imagery, bathymetry, lease boundaries), data layers (oyster density zones, disturbance polygons, recapture area polygons), and annotation layers (labels, legends, scale bars). Maps are generated using GIS software and may be exported as static image files (PNG, JPEG, TIFF), vector files (PDF, SVG), or interactive web maps (using web mapping libraries such as Leaflet, OpenLayers, or ESRI JavaScript API). Interactive web-based dashboards provide users with real-time access to monitoring

data, storage calculations, and alert notifications. Dashboards display summary statistics (total carbon dioxide stored, number of monitoring areas, number of active alerts), interactive maps allowing users to pan, zoom, and query features, and charts showing trends over time. Reports certifying quantified carbon dioxide storage or leakage amounts include detailed documentation of methodology, data sources, calculation parameters, and results. Certification reports may be reviewed by third-party verifiers, submitted to carbon credit registries, or provided to regulatory authorities as required by applicable programs or regulations.

What is claimed:

1. A method for recapturing leaked carbon dioxide from oyster-based carbon storage, comprising:
providing cultch material in an aquatic environment suitable for oyster colonization;
upon oyster colonization into an oyster colony, measuring oyster density on the cultch material in the oyster colony;
using an established correlation between oyster density and carbon burial rates, calculating a first carbon dioxide storage rate;
measuring an area of the oyster colony and multiplying the area by the first carbon dioxide storage rate to calculate a quantity of carbon dioxide stored in sediments beneath and surrounding the oyster colony;
determining sediment mobilization activities within a predefined distance of the oyster colony;
measuring a disturbed area of the oyster colony resulting from the sediment mobilization activities and multiplying the disturbed area by a predetermined second carbon dioxide storage rate for the disturbed area to provide a quantity of carbon dioxide leakage;
calculating a recapture area by dividing the quantity of carbon dioxide leakage by a product of a predetermined carbon burial rate and a recapture time period; and
placing additional cultch material in the aquatic environment, wherein a surface area covered by the additional cultch material is at least equal to the recapture area, to facilitate oyster colonization for recapture of the carbon dioxide leakage.

2. The method of claim 1, wherein measuring oyster density comprises dredging the oyster colony and counting the number of oysters collected per area dredged.

3. The method of claim 1, wherein the predefined distance comprises at least one mile from the oyster colony.

4. The method of claim 1, wherein the aquatic environment comprises a commercial shellfish lease and the predefined distance comprises at least one mile, circumferentially, from a boundary of the commercial shellfish lease.

5. The method of claim 1, additionally comprising deducting from the calculated quantity of carbon dioxide stored in sediments beneath and surrounding the oyster colony formed by the oysters: (i) 2.57 metric tons of carbon dioxide per acre per year for net ecosystem metabolism, and (ii) 43% of the carbon dioxide stored as calcium carbonate for biomineralization emissions to determine net carbon dioxide storage.

6. The method of claim 1, wherein determining sediment mobilization activities comprises searching a permit database for authorized construction activities.

7. The method of claim 1, wherein determining sediment mobilization activities comprises obtaining reports from lease holders.

8. The method of claim 1, wherein the predetermined carbon burial rate is 5 metric tons of carbon dioxide per acre per year.

9. The method of claim 1, wherein the recapture time period is three years.

10. The method of claim 1, wherein the first carbon dioxide storage rate and the second carbon dioxide storage rate are the same.

11. The method of claim 1, wherein the first carbon dioxide storage rate and the second carbon dioxide storage rate are different.

12. The method of claim 1, wherein the cultch material comprises at least one of shells, river rock, limestone, or clean recycled concrete.

13. The method of claim 1, wherein measuring oyster density comprises counting adult oysters over 20 millimeters in shell length.

14. The method of claim 1, wherein the aquatic environment comprises a commercial shellfish lease for cultivation of Crassostrea virginica.

15. The method of claim 1, wherein measuring oyster density comprises multiplying a count of oysters collected by dredging by a factor of 10 to account for dredge efficiency.

16. The method of claim 1, wherein measuring an area of the oyster colony comprises using geographic information system (GIS) software to interpolate a spatial extent of the oyster colony.

17. A system for monitoring carbon dioxide storage and leakage in oyster-based carbon capture, comprising:
a processor; and
a non-transitory computer-readable medium storing instructions that, when executed by the processor, cause the system to:
receive oyster density measurements from cultch material placed in an aquatic environment where oyster colonization into an oyster colony has occurred;
using an established correlation between oyster density and carbon burial rates, calculate a first carbon dioxide storage rate;
receive area measurements of the oyster colony and multiply the area by the first carbon dioxide storage rate to calculate a quantity of carbon dioxide stored in sediments beneath and surrounding the oyster colony;
determine sediment mobilization activities within a predefined distance from the oyster colony;
receive measurements of a disturbed area resulting from the sediment mobilization activities and multiply the disturbed area by a second carbon dioxide storage rate for the disturbed area to provide a quantity of carbon dioxide leakage;
calculate a recapture area by dividing the quantity of carbon dioxide leakage by a product of a predetermined carbon burial rate and a recapture time period; and
generate an output indicating the recapture area for placing additional cultch material in the aquatic environment to facilitate oyster colonization for recapture of the quantity of carbon dioxide leakage.

18. A computer-implemented method for managing recapture of leaked carbon dioxide from oyster-based carbon storage, comprising:
receiving, by a processor, oyster density measurements from an oyster colony formed on cultch material;
calculating, by the processor using an established correlation between oyster density and carbon burial rates stored in memory, a first carbon dioxide storage rate;
receiving, by the processor, area measurements of the oyster colony and multiplying the area by the first carbon dioxide storage rate to calculate a quantity of carbon dioxide stored in sediments beneath and surrounding the oyster colony;
receiving, by the processor, sediment mobilization activities within a predefined distance of the oyster colony;
receiving, by the processor, measurements of a disturbed area of the oyster colony resulting from the sediment mobilization activities and multiplying the disturbed area by a predetermined second carbon dioxide storage rate for the disturbed area to provide a quantity of carbon dioxide leakage;
calculating, by the processor, a recapture area by dividing the quantity of carbon dioxide leakage by a product of a predetermined carbon burial rate and a recapture time period; and
generating, by the processor, output data indicating a surface area for placement of additional cultch material, wherein the surface area is at least equal to the recapture area, to facilitate oyster colonization for recapture of the carbon dioxide leakage.

19. The method of claim 18, additionally comprising generating, by the processor, a geospatial map displaying: (i) the oyster colony area with associated carbon dioxide storage quantities, (ii) the disturbed area with associated carbon dioxide leakage quantities, and (iii) a recommended location for placement of the additional cultch material corresponding to the calculated recapture area.

20. The method of claim 18, wherein receiving sediment mobilization activities comprises the processor automatically querying a permit database to identify construction activities within the predefined distance of the oyster colony.
